(19) United States
(12) Patent Application Publication
(10) Pub. No.: US 2019/0005957 A1
(43) Pub. Date: Jan. 3, 2019

(54) DEVICE AND METHOD FOR CONTROLLING APPLICATION PROGRAM USING VOICE COMMAND UNDER PRESET CONDITION

(71) Applicant: Christopher Jaehyun YOON, New York, NY (US)

(72) Inventor: Christopher Jaehyun YOON, New York, NY (US)

(21) Appl. No.: 16/019,960

(22) Filed: Jun. 27, 2018

(30) Foreign Application Priority Data
Jun. 28, 2017 (KR) 10-2017-0081636

(51) Int. Cl. G10L 15/22; G10L 15/07

(52) U.S. Cl. CPC G10L 15/22; G06F 17/2795; G10L 2015/223; G10L 15/07

(57) ABSTRACT

Disclosed are an application control device and method that activates a speech recognition mode only under a specific condition and allows control of a smart terminal by a voice input or a touch input under the specific condition. The device includes a condition setting module for setting a speech recognition control condition including an event occurrence or a device status, a command setting module for designating a set of voice commands to be recognized under the set speech recognition control condition, a command recognition module for activating the speech recognition mode and recognizing the voice commands designated by the command setting module when an event included n the speech recognition control condition occurs, and an application control module for converting the recognized voice command into an application control signal to control an application when the designated voice command is recognized under the speech recognition control condition.

### CROSS-REFERENCE TO RELATED APPLICATIONS

This application is based on and claims priority of Korean Patent Application No. 10-2017-0081636 filed on Jun. 28, 2017 in the Korean Intellectual Property Office, the disclosure of which is incorporated herein in its entirety by reference.

### FIELD

The present invention relates to a method of controlling an application program using a voice recognition technology. More particularly, the present invention relates to a device and method for controlling an application program in a smart terminal using voice commands only under preset conditions.

### BACKGROUND

Unless otherwise stated herein, the disclosures in this section are not prior art to the claims of this application and should not be construed as prior art only for the reason that the disclosures are described in this section.

Speech recognition (also called voice recognition) refers to a technology for understanding human speech and converting it into computer-readable code information. Specifically, it is a process of receiving a sound signal composed of sound waveforms as input data, identifying words or word sequences, and extracting the meaning thereof. Speech recognition technology has been employed in smart terminals, automobiles, and Internet of Things (IoT) technologies, etc.

Studies on speech recognition have been conducted since the 1950s, but even speech recognition devices (SRD) developed by the leading group have many limitations in terms of technology level.

The volume classes of recognition target words may include a volume class of several tens of thousands of words, a volume class of several hundreds of thousands of words, and a volume class of an infinite number of words. In the case of spontaneous speech (natural language), there is much difficulty in recognition of speech than other speech forms because normal spontaneous speech does not follow the linguistic grammar and acoustic phonation patterns differ from person to person.

Actually, since a voice command recognition error frequently occurs in a smart terminal equipped with a voice recognition function, many users do not use the voice recognition function even though the voice recognition function is built in the smart terminal.

### SUMMARY

Accordingly, the present invention has been made in view of the problems occurring in the related art and the present invention is intended to provide an application program control device and method for enabling a user to accurately control a smart terminal using a set of voice commands only under preset conditions, in which the set of voice commands differs from condition to condition.

According to one embodiment, a device for controlling an application program in a smart terminal, includes: a condition setting module for setting speech recognition control conditions including an event condition and a device status condition such that a speech recognition mode is activated under a specific condition whereby the smart terminal can be controlled by a voice input or a display touch input under the specific condition; a command setting module for designating a set of voice commands that are dedicated to each of the speech recognition control conditions; a command recognition module for activating a voice recognition mode when at least one event occurs which is included in the speech recognition control conditions set by the condition setting module, and recognizing the designated voice commands; and an application program control module for converting an input voice command into a smart terminal application program control signal to control an application program in the smart terminal when the input voice command is one of the designated voice commands designated for a corresponding speech recognition control condition.

According to another embodiment, a method of controlling an application program in a smart terminal, includes: (A) by a condition setting module, setting speech recognition control conditions including an event condition and a device status condition such that a speech recognition mode provided in the smart terminal is activated only under the preset speech recognition control conditions whereby the application program in the smart terminal is allowed to be controlled by a voice input or a display touch input; (B) by a command setting module, designating a set of voice commands dedicated to a current speech recognition control condition among the preset speech recognition control conditions; (C) recognizing a voice command that matches at least one voice command included in the set of voice commands designated by the command setting module when an event condition included in the speech recognition control conditions occurs; (D) by an application control module, controlling an application program in a smart terminal by converting the input voice command into a smart terminal application program control signal.

The device and method for controlling an application program in a smart terminal, described above, allow a user to set at least one specific condition for activation of voice recognition, prepare a set of voice commands dedicated to each specific condition for activation of voice recognition, and recognizes voice commands included in the set of voice commands under any one of the specific conditions, whereby the device and method dramatically reduces a voice command recognition error rate which is normally found to be high in a spontaneous speech (natural speech) condition, and thus a user can accurately control his or her smart terminal using voice commands only under specific conditions set by the user.

The infrequent use of voice control on smart terminals equipped with a voice command control function was primarily attributed to a low success rate for voice command recognition. However, according to the present disclosure, since potential voice commands to be recognized and used under a specific condition are limited to a predetermined volume of words which are preliminarily set, a success rate for voice control on a smart terminal can be increased compared with conventional natural speed-based voice control.

Voice-based control on a smart terminal is very convenient in many events such as responding to a morning call or to a call when driving, etc. To this end, the present disclosure improves user convenience in using a smart terminal by enabling accurate control on a smart terminal using voice commands in some conditions in which it is difficult for a user to reach or touch the smart terminal.

It should be understood that the advantages, effects, and features of the present invention are not limited to those described above but include all advantages, effects, and features that are not explicitly stated here but can be deduced from the detailed description of the invention or from the recitation of the claims.

### DRAWINGS

FIG. 1 is a schematic block diagram illustrating an application control device according to one embodiment of the present invention;

FIG. 2 is a block diagram illustrating the overall construction of an application control device according to another embodiment of the present invention;

FIG. 3 is a diagram illustrating operation of an application control device;

FIG. 4 is a flowchart illustrating an application control method according to one embodiment of the present invention; and

FIG. 5 is a diagram illustrating exemplary operation of an application control device.

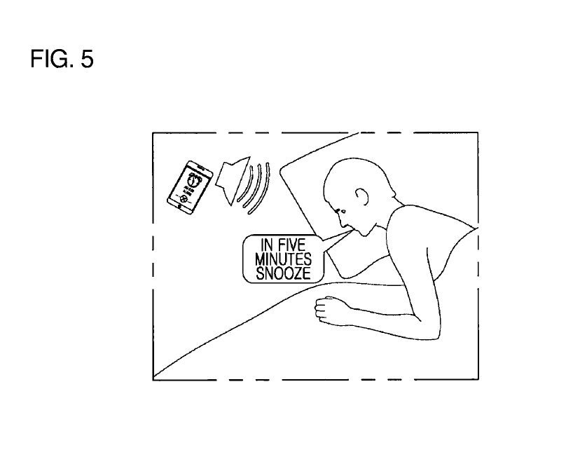

### DETAILED DESCRIPTION

Advantages and features of the present invention and ways for accomplishing the same will become apparent with reference to the embodiments which will be described in detail below in conjunction with the accompanying drawings. The present invention may, however, be embodied in many different forms and should not be construed as limited to the embodiments set forth herein. Rather, these embodiments are provided so that this disclosure will be thorough and complete, and will fully convey the concept of the invention to those skilled in the art. Thus, the present invention is only defined by the scope of the claims. Throughout the description provided herein, like reference numerals refer to like elements.

In the following description of the present invention, detailed description of known functions and configurations incorporated herein will be omitted when it may make the subject matter of the present invention rather unclear. The following terms are defined in consideration of the functions in the embodiments of the present invention, which may vary depending on the intention of the user, the operator, or the custom. Therefore, the definition should be based on the contents throughout this specification.

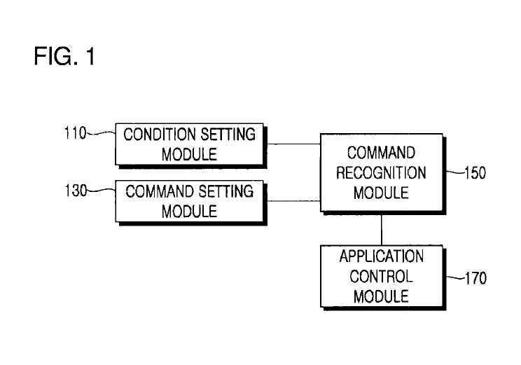

FIG. 1 is a schematic block diagram of an application control device according to one embodiment.

Referring to FIG. 1, an application control device according to one embodiment of the present invention includes a condition setting module 110, a command setting module 130, a command recognition module 150, and an application control module 170. The term “˜module” used herein should be interpreted as a software or hardware component, or a combination thereof within the context. The software may be machine language, firmware, embedded code, and an application program. The hardware may be a circuit, a processor, a computer, an integrated circuit, an integrated circuit core, a sensor, a micro-electro-mechanical system (MEMS), a passive device, or a combination thereof.

The condition setting module 110 sets a specific condition in which to activate speech recognition mode. For example, the condition setting module 110 sets multiple speech recognition control conditions in which to activate voice recognition, the speech recognition control conditions including an event occurrence, a device status, and a device environment such that the smart terminal can be controlled by a voice input or a touch input only in speech recognition control conditions set by the condition setting module 110.

When the smart terminal is in any one of the speech recognition control conditions that are set by the condition setting module 110, the command setting module 130 generates a set of voice commands to be recognized under a current speech recognition control conditions among the multiple speech recognition control conditions. That is, the set of voice command varies from condition to condition. For example, when the speech recognition control condition is set to “activation of a camera application program”, the command setting module 130 designates the words or phrases for controlling the camera, such as “cheese”, “Kimchi”, “shot”, “one, two, three”, as voice commands to be used in the condition “activation of a camera application program”. In this case, when the camera of the smart terminal is activated, the speech recognition mode is automatically activated, and the camera application program can be controlled by the voice commands set by the command setting module 130.

Further, in the embodiment, the command setting module 130 may learn voice commands to be recognized in advance. For example, the command setting module 130 preliminarily learns voice commands such as “in five minutes” and “snooze” which the user is most likely to issue for controlling the smart terminal through voice recognition. Therefore, a recognition success rate for voice command can be increased. The voice commands to be set by the command setting module 130 may differ from user to user according to user life patterns and user device usage patterns.

When the smart terminal is in any one of the speech recognition control conditions which are set with the condition setting module 110, the command recognition module 150 activates the speech recognition mode and recognizes voice commands which are set for per condition with the command setting module 130.

The application control module 170 controls the application by converting an input voice command into a smart terminal application control signal when the smart terminal is in any one of the speech recognition control conditions which are preset, and when an arbitrary voice command among the voice commands which are set for the speech recognition control condition is input. More particularly, when the camera is activated whereby the speech recognition control condition is satisfied, when any one of the voice commands such as “cheese”, “Kimchi”, “shoot”, “one, two, three” which are set for the specific driving condition of the camera, the voice input is converted into a photographing signal so that the camera is driven to take a picture. By preparing a set of voice commands which varies from condition to condition in advance, an error rate for voice command recognition provided in the smart terminal can be reduced, and a user can accurately control the own smart terminal in the preset specific conditions is met.

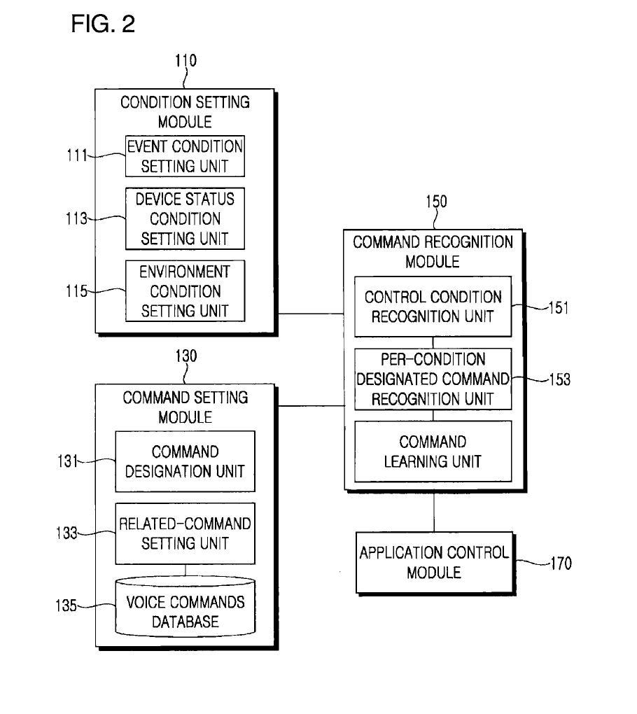

FIG. 2 is a block diagram illustrating the overall construction of an application control device according to one embodiment of the present invention.

Referring to FIG. 2, the condition setting module 110 includes an event condition setting module 111, a device status condition setting module 113, and an environment condition setting module 115. The command setting module 130 includes a command designation unit 131, a related command setting unit 133, and a voice commands database 135. The command recognition module 150 includes a control condition recognition unit 151 and a per-condition designated command recognition unit 153.

The event condition setting module 111 of the condition setting module 110 sets event-related conditions among the speech recognition control conditions in which the speech recognition mode is activated in the smart terminal. For example, the event condition setting module 111 may set starting of predetermined applications as event conditions, in which the predetermined applications may be application programs related to a morning call, an alarm, a phone, a camera, etc.

The device status condition setting unit 113 sets conditions in which the speech recognition mode is activated due to the status of the smart terminal as the device status conditions. For example, according to the battery level, the connection state with another device, an internal temperature or an external temperature of the smart terminal, etc., the speech recognition condition is activated. In the embodiment, the device status condition setting unit 113 may automatically deactivate the speed recognition mode in a state in which it is not desirable to activate the speech recognition mode, for example, when the battery level drops below a predetermined level or when the internal temperature of the smart terminal exceeds a predetermined temperature, although the other speech recognition control conditions are satisfied.

The environment condition setting module 115 may set a specific date and time or a specific position set by a user as the environment condition in which the speech recognition mode is to be activated. For example, in a case in which a user drives a car at a specific time every day, the environment condition setting module 115 may activate the speech recognition mode during a time zone in which the user is driving a car.

The command designation unit 131 of the command setting module 130 designates voice commands which differ from condition to condition. Therefore, only when the designated voice command is issued under a specific condition, the voice command is converted into an application program control signal. For example, when the event condition setting module 111 sets an event of a morning call as the speech recognition control condition, the command designation unit 131 may designate specific voice commands such as “dismiss”, “snooze”, and “in five minutes” which are related to control of a morning call. Therefore, when the morning call event occurs, the speech recognition mode is activated, and only the designated voice commands can be recognized.

The related command setting unit 133 sets related voice commands per each specific condition on the basis of the voice commands database 135 which is stored in the smart terminal or obtained through a network communication.

The related command setting unit 133 may set foreign language translations, synonyms, and derivates of the designated voice commands designated by the command designation unit 131 as the related voice commands. More particularly, returning back to the above example, the related voice commands of the voice command “dismiss” which may be used in the morning call event may include “dismiss”, “ [symbol] ” which is a translated Korean ward translated from the word “dismiss”, “stop”, “ [symbol] ” which is a translated Korean word translated from the word “stop”, etc. The related voice commands also may include Chinese words corresponding to “alarm off”.

The command learning unit 155 may learn commands input by a user in advance. For example, the command learning unit 155 may learn commands which are frequently input in a specific application program used by a user. The commands that are learned by the command learning unit 155 may include frequently used commands such as “snooze” and “in five minutes” that differ according to user daily life or per-user smart terminal usage pattern. Due to the presence of the command learning unit 155, the device according to the present embodiment has the learning function as well as the speech recognition function. Therefore, a recognition success rate for voice commands which are frequently used by a user can be remarkably increased. That is, since voice commands such as “in five minutes” can be preliminarily learned, the smart terminal can be improved in the voice command recognition rate.

The control condition recognition unit 151 of the command recognition module 150 determines whether the smart terminal satisfies the preset speech recognition condition. When the smart terminal satisfies the present speech recognition condition, when a command set to be recognized in a specific condition is successfully recognized, the per-condition designated command recognition unit 153 transmits the recognized command to the application control module 170 so that the recognized voice command can be converted into an application control signal. The infrequent use of the speech recognition function built generally in most smart terminals was primarily due to a significantly low recognition rate. However, in the case of the present disclosure, since the volume or type of commands to be used is limited, the recognition rate can be improved in comparison with the case of natural language recognition.

In addition, the application control device according to the embodiment can learn voice commands to be recognized in advance. For example, in a manner that a user makes the application control device to learn voice commands such as “in five minutes”, the voice command recognition range can be remarkably improved.

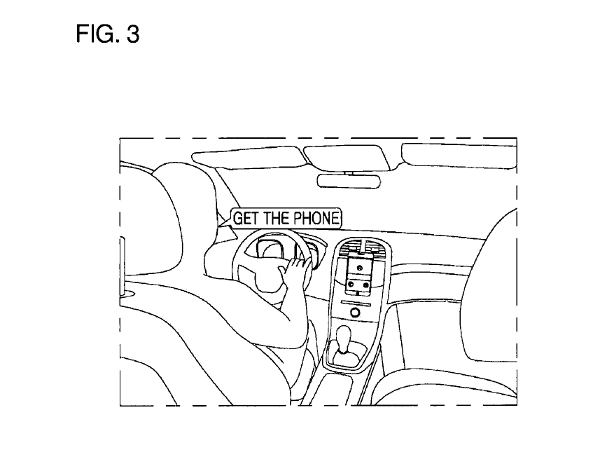

FIG. 3 is an operation example of the application control device according to the embodiment.

As illustrated in FIG. 3, in the case in which an event of responding to a call is set as the voice command recognition condition, and the words “get”, “hang up”, “decline”, “sending message of unable to get a call”, and the like are designated as voice commands to be recognized in the event of call reception, when the event of call reception occurs in the user smart terminal, the speech recognition mode is activated to recognize the commands set by the user. In this way, it is possible to control the smart terminal. That is, it is possible to respond to or decline the call using voice commands. As described with reference to FIG. 3, the present disclosure automatically activates speech recognition mode when a specific event occurs in a condition (for example, during exercise) in which it is difficult to control the smart terminal by means of a touch input, and designates differently designates voice commands according to each type of events. Therefore the present disclosure minimizes speech recognition errors which frequently occur in processing of natural language and enables accurate control on a smart terminal using voice commands, thereby maximizing user convenience in using smart terminals.

Hereinafter, an application control method according to embodiment of the invention will be described. Features and functions of the application control method are basically the same as those of an application control device. Therefore, a description of FIGS. 1 to 3 will be omitted here.

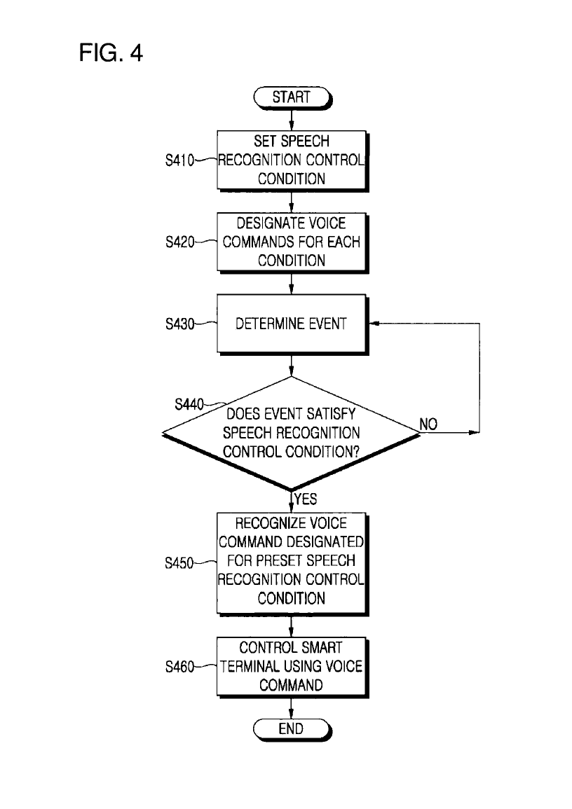

FIG. 4 is a flowchart illustrating an application control method according to one embodiment.

At S410, a condition setting module 110 sets a specific condition in which to activate a speech recognition mode in a smart terminal. For example, an event condition in which a specific application program related to a morning call, an alarm, a phone, and a camera is activated may be set as one of speech recognition conditions. In addition, a specific time or position set by a user also may be set as one of speech recognition conditions. In addition, a device status such as a battery level, a connection state with another device, and an internal and external temperature of a smart terminal may be used as the speech recognition condition.

In the embodiment, when the battery level drops to below a predetermined level, or when an internal temperature of the smart terminal reaches or exceeds a caution level due to simultaneous activation of a plurality of application programs, that is, in conditions in which it is difficult to run the speech recognition mode, or when the activation of the speech recognition function is a factor of over loading of the smart terminal, although the smart terminal satisfies other speech recognition conditions, the speech recognition mode may be automatically deactivated. At S420, voice commands to be recognized are set for each speech recognition control condition are designated. For example, a morning call event occurs as the voice recognition control condition, commands such as “set an alarm to ring in five minutes”, “dismiss” may be designated to control a morning call application. In the embodiment, related commands that are related to the commands designated to be used in the speech recognition control condition may be also designated. The related commands may include translations synonyms, and derivates of the designated commands. At S430, events occurring in the smart terminal and device status information of the smart terminal are recognized.

At S440, it is determined whether the events and the device status information satisfy the speech recognition control condition. When the events and the device status information do not satisfy the speech recognition control condition, returning to S430 is performed. When the speech recognition control condition is satisfied, at S450, the speech recognition mode is activated and the commands designated to be recognized in the speech recognition control condition are recognized. At S460, the command recognized by the control mode 170 is converted into a smart terminal application control signal so that an application program in the smart terminal can be controlled.

In brief, the application control device and method described above set speech recognition conditions, designate voice commands that differ from condition to condition, and recognize the designated voice commands in a specific condition. Therefore, a speech recognition error rate which is normally high in the case of processing natural language (spontaneous speech) can be reduced, and a user can accurately control his or her smart terminal in a specific condition using voice commands. The primary reason of infrequent use of the speech recognition was a significantly low recognition success rate. However, in the present disclosure, voice commands expected to be used in a specific condition are limited to a small volume, and the speech recognition rate in the smart terminal can be improved in comparison with smart terminals in which natural language is processed during speech recognition.

In addition, in conditions such as a morning call event and a call reception event during driving, in which speech recognition control is convenient or a touch invent is impossible, the present disclosure enables a user to accurately control the smart terminal using voice commands, which results in improvement in user convenience in use of the smart terminal.

It will be understood by those skilled in the art that various changes can be made without departing from the spirit and scope of the invention as defined by the appended claims. Therefore, the protection scope of the present disclosure is not limited to the embodiments described above.

What is claimed is:

1. A device for controlling an application program, the device comprising:
a condition setting module for setting a speech recognition control condition in which a speech recognition mode is activated and a smart terminal is controlled by a voice command or a touch input, the speech recognition control condition being at least one of an event condition occurring in the smart terminal and a device status condition;
a command setting module for designating a set of voice commands to be recognized in the speech recognition control condition which is set by the condition setting module;
a command recognition module for activating the speech recognition mode and recognizing a voice command included in the set of voice commands prepared by the command setting module when an event included in the speech recognition control condition set by the condition setting module occurs; and
an application control module for converting a voice command into a smart terminal control signal to control an application program when at least one of the voice commands included in the set of voice commands designated by the command setting module is recognized in the speech recognition control condition.

2. The device according to claim 1, wherein the speech recognition control condition includes an event condition meaning a condition in which a specific application program related to a morning call, an alarm, a call, and a camera is activated, an environment condition including a specific time or position set by a user, and a device status condition including a battery level, a connection state with another device, and an internal temperature of the smart terminal.

3. The device according to claim 1, wherein the command setting module designates a set of voice commands that differs for each speech recognition control condition, and the command recognition module recognizes at least one of the voice commands designated for a specific speech recognition control condition which is set, among the speech recognition control conditions.

4. The device according to claim 1, wherein in a case where occurrence of a morning call event is set as the speech recognition control condition, when the morning call event occurs, the speech recognition mode is activated and only designated commands for controlling the morning call event, including “dismiss”, “snooze”, and “in five minutes”, are recognized as the voice commands to control the morning call event.

5. The device according to claim 1, wherein the command setting module includes a related command setting unit for setting related commands including foreign-language translations, synonyms, and similar phrases of the designated commands for each speech recognition control condition.

6. The device according to claim 1, wherein the command setting module includes a command learning unit that preliminarily learns commands designated by a user.

7. The device according to claim 1, wherein when it is determined that activation of a speech recognition function results in overloading of the smart terminal in terms of a battery level and an internal temperature of the smart terminal, the speech recognition mode is automatically cancelled even though the smart terminal is under the speech recognition control condition.

8. A method of controlling an application program in a smart terminal including a condition setting module, a command setting module, a command recognition module, and an application control module, the method comprising:
(A) by the condition setting module, setting a speech recognition control condition including an event condition and a device status condition such that a speech recognition mode of the smart terminal is activated only under set speech recognition control condition and the smart terminal is controlled by a voice input or a touch input under the set speech recognition control condition;
(B) by the command setting module, designating a set of voice commands that vary according to the speech recognition control condition;
(C) by the command recognition module, when an event included in the set speech recognition control condition occurs, recognizing a command designated by the command setting module; and
(D) by the application control module, converting the recognized command into a smart terminal application control signal to control the application program in the smart terminal.

9. The method according to claim 8, wherein the speech recognition control condition includes activation of a morning call, an alarm, a phone, and a camera as the event condition, includes a specific time or position set by a user as the environment condition, and includes a battery level, a connection state with another device, an internal and external temperature of the smart terminal as the device status condition.

10. The method according to claim 8, wherein the designating of the voice command to be recognized designates the voice commands that vary according to the set speech recognition control condition, whereby when the smart terminal is under the speech recognition control condition, only the voice commands designated for the set speech recognition control condition are recognized.

11. The method according to claim 8, wherein in a case where occurrence of a call reception event is set as the speech recognition control condition, when the call reception event occurs, the speech recognition mode is activated in the smart terminal, and the smart terminal controls the call reception event by recognizing only commands for controlling the call reception event, including “get”, “transmit message of a state of inability to respond to a call”, “hang up”, and “decline”.

12. The method according to claim 8, wherein the speech recognition mode is automatically cancelled according to the device status condition including a battery level and an internal temperature of the smart terminal.

13. The method according to claim 8, the designating of the set of voice commands to be recognized comprises:
setting related commands including foreign language translations, synonyms, and similar phrases of the designated voice commands.

14. The method according to claim 8, the designating of the set of voice commands to be recognized comprises:
learning commands frequently input by a user.
